(19) United States
(12) Patent Application Publication
(10) Pub. No.: US 2024/0011873 A1
(43) Pub. Date: Jan. 11, 2024

(54) METHOD FOR TESTING ELECTRONIC CONTROL UNITS OF AIRBAG PROTECTION DEVICES AND TESTING MACHINE DESIGNED TO IMPLEMENT SAID METHOD

(71) Applicant: ALPINESTARS RESEARCH S.P.A., Maser (Treviso) (IT)

(72) Inventors: Giovanni MAZZAROLO, Coste di Maser (Treviso) (IT); Lorenzo NARDO, Ponzano Veneto (Treviso) (IT); Riccardo FAGGIAN, Dolo (Venezia) (IT); Matteo TODARO, Preganziol (Treviso) (IT)

(21) Appl. No.: 18/253,200

(22) PCT Filed: Nov. 18, 2021
(86) PCT No.: PCT/IB2021/060697

§ 371 Date: May 16, 2023

(30) Foreign Application Priority Data
Nov. 19, 2020 (IT) 102020000027813

(51) Int. Cl. G01M 99/00; G01P 15/18

(52) U.S. Cl. CPC G01M 99/004; G01P 15/18

(57) ABSTRACT

The present invention relates to a method for testing electronic control units of airbag protection devices. The method comprises the steps of: a) providing a dataset (D) representing simulated movements in a space defined by three axes (X, Y, Z); b) filtering the linear acceleration measurements (Ax, Ay, Az) of said dataset (D) to remove low frequencies; c) uploading on the electronic control unit to be tested an activation algorithm capable of identifying a danger situation for the user; d) programming the electronic control unit to be tested to send and/or internally record an activation signal when the activation algorithm identifies a danger situation; e) moving the electronic control unit within a three-dimensional workspace (W) to replicate said dataset (D) as filtered in step b); f) verifying if an activation signal is sent and/or internally recorded by the electronic control unit when the activation algorithm identifies a danger situation. The invention also relates to a testing machine designed to implement said method.

The present invention relates to a method for testing electronic control units of airbag protection devices. In particular, the present invention relates to a method for testing electronic control units of airbag protection devices designed to be used in all the fields where an effective protection against impacts and/or falls must be obtained. For example, this type of airbag protection device is suitable for being integrated into garments used by motorcyclists, cyclists or skiers.

Moreover, the present invention relates to a testing machine designed to implement such a method.

For sake of clarity, in the present description reference will be made, in a not limiting way, to the sector of motorcycle industry and, in particular, to the sector of motorcycle clothing.

The use of airbag protection devices associated with jackets, suits and protective devices designed for motorcyclists is increasingly widespread. In particular, the use of electronically activated airbag protection devices is increasing.

These airbag protection devices generally comprise at least one airbag which is electronically triggered so as to be automatically activated in the event of an accident to protect the motorcyclist from the impact when falling and/or during a collision with other vehicles.

At present, activation of the airbag is managed by a control unit connected to one or more sensors.

Generally, the sensors consist of a plurality of accelerometers and/or gyroscopes.

The accelerometers are able to detect the accelerations to which the motorcyclist is subject during travel and in particular the negative accelerations which affect the motorcyclist in the event of an impact.

The gyroscopes are able to sense inertial angular motions and thus they are able to provide feedback about position and orientation of the body of the motorcyclist.

The electric signals generated by the accelerometers and/or gyroscopes are sent to the control unit on which a triggering algorithm is loaded.

When predetermined decelerations and inertial angular motions set up and/or their mathematical elaboration in the triggering algorithm are exceeded, the control unit triggers the inflation device connected to the airbags so as to inflate the latter.

However, while in the automotive technical field the airbag activation is operated by means of sensors provided on the car, whose dynamics is relatively simple and this led to a standardization of activation mechanism, in the motorcycle technical field the airbag activation involves many parameters.

As a matter of fact, the complex dynamics of the motorcycle and the further degree of freedom introduced by the possible movements of the motorcyclist result in complex activation algorithms.

As a matter of fact, the possible accidents undergone by a motorcyclist are of different types.

For example, the motorcyclist may have a “high side” accident, caused by a loss and a successive quick recovery of traction, which results in a throwing of the rider from the bike.

Alternatively, the motorcyclist can be involved in a “low side” accident, when, due to a loss of traction, he falls and skids on the ground.

Finally, the motorcyclist can have an accident caused by the impact of his vehicle with a car or a further different obstacle.

Consequently, in order to be able to promptly detect a danger situation for the rider, the control units need to check movements having six degrees of freedom: three translational coordinates and three angular coordinates.

Therefore, the need to have reliable and predictable crash detection algorithms is a major task for manufacturers.

As a matter of fact, a failure of the algorithm running on the control unit of the protection system can result in a failure of activation of the airbag, when it is needed, or conversely, in an activation of the airbag when it is not needed, the so-called false positive activations. Both circumstances are obviously to be avoided.

Recently, tests based on computer simulations have been developed in order to test the reliability of the algorithms running on the control units of the airbag protection devices.

However, there is still the need to prove the effectiveness of the crash detection algorithms on “real” crash tests.

Moreover, computer simulations may be useful for detecting the parameters involved in a crash but are not helpful to detect a possible failure of the algorithm in false positive situations.

Besides, computer simulations may be useful only to test a predetermined algorithm, but not when a control unit needs to be tested as a ‘black box’ unit, i.e. when there is the need to test the behavior of a control unit without having information on the algorithm present inside, e.g. during a field test assessment.

Furthermore, “real” crash tests are highly expensive and can be carried out in a limited number of situations, as a final stage of the development of the activation algorithm.

Additionally, the “real” crash tests to reproduce the hitting of an obstacle or the loss of control of the motorbike need a considerable amount of space, not commonly available in a laboratory.

The known machines for laboratory, like for example cable-driven robots, are able to reproduce linear movements, but they are able to simulate limited angular movements, which are not sufficient to reproduce the real movements of a driver of a motorcycle when he is on the vehicle.

At the same time, a “real” crash test produces relevant damages to the objects (motorbikes, cars, dummies) involved in the crash, even if these damages are not necessary to prove the effectiveness of the activation algorithm.

The main object of the present invention is therefore to provide a method for testing electronic control units of airbag protection devices configured to overcome the drawbacks mentioned above with reference to the known crash tests.

More specifically, the main object of the present invention is to provide a method for testing electronic control units of airbag protection devices suitable for being carried out in a laboratory without affecting the reliability thereof.

Another object of the present invention is to provide a method for testing electronic control units, which does not cause damages to the objects involved in the tests, so as to reduce costs and save time.

A further object of the present invention is to provide a method for testing electronic control units having a high reliability.

Finally, an object of the present invention is to make available a testing machine suitable for implementing this method and having a simplified structure.

The above-mentioned objects, and other objects that will better appear in the following of the present description, are achieved by the method according to claim 1 and the testing machine according to claim 9.

The advantages and the characteristic features of the invention will appear more clearly from the following description of a preferred, but not exclusive, embodiment of the invention which refers to the accompanying figures in which:

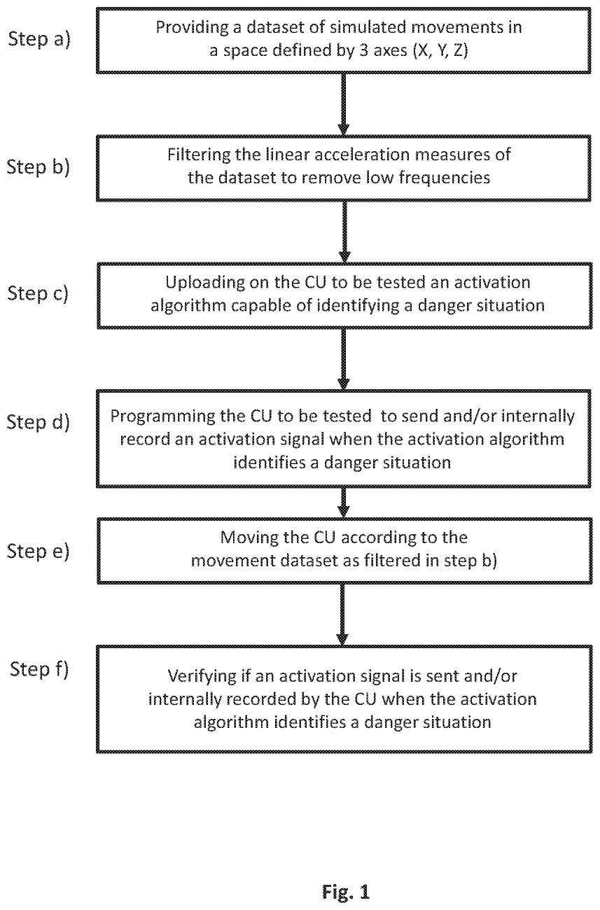

FIG. 1 is a simplified flow chart of a method according to the invention;

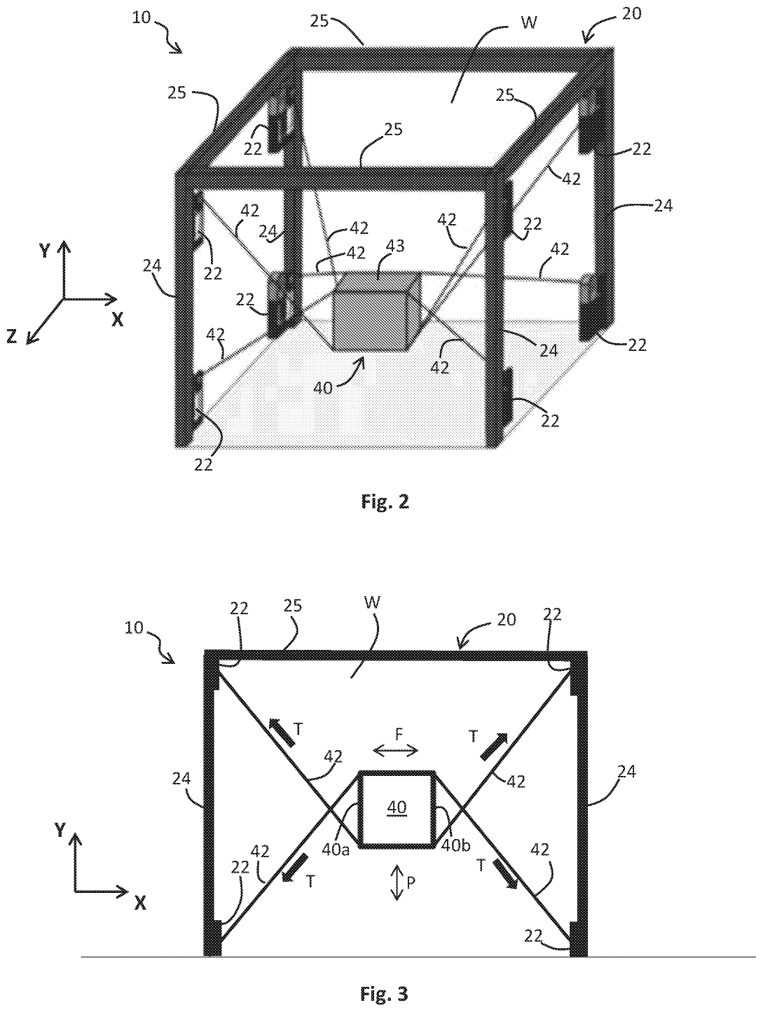

FIG. 2 is a simplified perspective view of an exemplary embodiment of the testing machine according to the invention;

FIG. 3 is a simplified front view of the testing machine of FIG. 2;

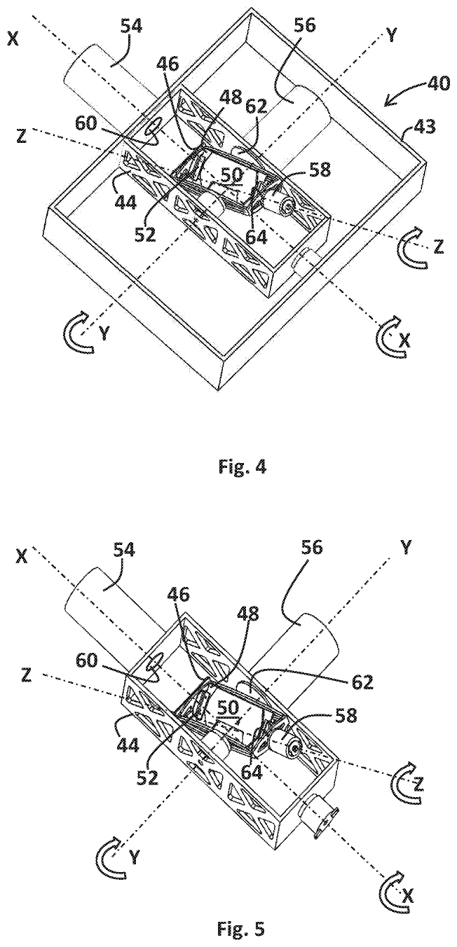

FIG. 4 is a simplified perspective view of the end effector of the testing machine of FIG. 2;

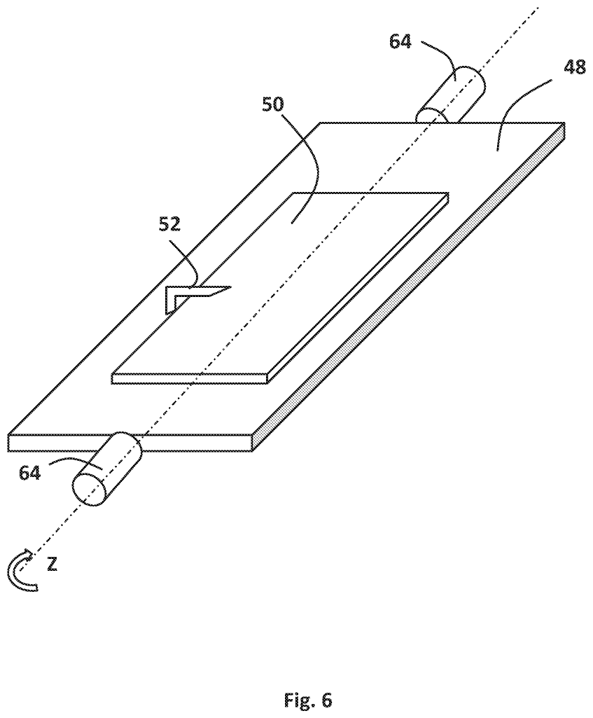

FIG. 5 is a view similar to FIG. 4, wherein the outer frame of the end effector has been removed;

FIG. 6 is a schematic enlarged view of the platform of the end effector on which a control unit to be tested is applied.

The present invention relates to a method for testing electronic control units of airbag protection devices adapted to be worn by a user.

Preferably these airbag protection devices are designed to be integrated or to be applied on protective garments, like for example vests, jackets, suits, etc.

These airbag protection devices are designed for being used in particular by motorcyclists. Nevertheless, such protection devices can also be advantageously used by cyclists or in other fields where an effective protection of the user's body must be obtained.

The control units to be tested are designed for processing at regular time intervals (for example 2 ms) acceleration data detected by acceleration sensors of the protection device. If the control unit detects, on the basis of an algorithm implemented in the control unit, that a danger situation is occurring, it sends an activation signal to an inflator device connected to the inflatable bag of the protection device so as to inflate the bag.

As a danger situation should be intended a situation when the sensors, applied on the protection device or on a vehicle, detect a sudden acceleration or deceleration. In particular, when the user of the airbag protection device is on a vehicle, like for example a motorcycle, a sudden acceleration or deceleration will identify for example that the motorcycle has hit an obstacle or that the user has lost the control of the motorcycle being thrown from the saddle.

With reference to FIG. 1, the method of the present invention comprises a first step a) of providing a dataset D representing simulated movements of a user in a space defined by three axes X, Y, Z, orthogonal to each other, in a time interval T1.

Said dataset D has the function to characterize by means of numeric values the spatial movement of the user to be simulated during the testing of the control unit. In other words, as it will clearly be described in the following, the dataset D provides a numerical representation of the user's movement which needs to be replicated during the testing of the control unit.

The time interval T1 preferably is comprised between 1 s and 60 s.

Said dataset D comprises at least three linear acceleration measurements Ax, Ay, Az along the three axes X, Y, Z and at least three angular acceleration measurements Gx, Gy, Gz around the three axes X, Y, Z.

Advantageously, said dataset D can comprise additional data concerning the movement to be simulated, like for example speed data and position data with reference to the space defined by the axes X, Y, Z in the time interval T1.

Preferably, said dataset D representing simulated movements is obtained by collecting real movement data of a user involved in a crash, namely it comes from the analysis of data recovered, after the crash, from the control units of the protection devices worn by the users.

Alternatively, said dataset D can be obtained by artificially creating movement data of a user, namely it comes from numerical modelling simulations.

In any case, both the “real data” and the “simulation data” can be pre-elaborated to include in the dataset additional signals, like for example random noises, disturbances, etc.

In the first case (“real data”), the control unit will be tested to verify whether in the presence of data reproducing a real crash, an activation signal is emitted by the control unit.

In the second case (“simulation data”), since the dataset can be created to simulate extreme situations which do not necessarily need the activation of the airbag, the control unit will be tested to verify whether the activation signal is emitted or not, according to initial inputs.

The method of the present invention also comprises a filtering step b) of the linear acceleration measurements Ax, Ay, Az of the dataset D to remove the frequencies below a cut-off frequency along the three axes X, Y, Z.

Said step is carried out to eliminate from the “real data” the low frequencies of the linear acceleration measurements detected by the sensors of the protection devices. As a matter of fact, these low frequencies are mainly responsible for the large space movements during the use of the airbag protection device by a motorcyclist. However, such components of the linear acceleration measurements can be ignored since they are common in normal movements of the motorcyclist, namely in movements that must not cause the activation of the airbag.

The filtering step b) is also useful in case the dataset D is formed by “simulation data”. As a matter of fact, nowadays many simulation tools are available for simulating real movements of a bicycle or a motorcycle. However, the “simulation data” so obtained include low frequency components of the accelerations that need to be filtered for being reproduced in a space having limited dimensions.

Preferably, in the filtering step b) the cut-off frequency is comprised between 1 Hz and 20 Hz.

The filtering step b) can be carried by using common high-pass filters.

The method further comprises a step c) of uploading on the electronic unit to be tested an activation algorithm; said activation algorithm being capable of identifying a danger situation for the user.

Moreover, the method comprises the step d) of programming the electronic control unit to be tested to send and/or internally record an activation signal when the activation algorithm identifies a danger situation.

Such an activation signal is preferably the triggering signal that, during normal use of the control unit, is sent by the control unit to the inflator device of the airbag if a danger situation is identified in order to cause the inflation of the bags.

The method further comprises the step e) of moving the electronic control unit within a three-dimensional workspace W to replicate the dataset D representing simulated movements as filtered in step b).

As above mentioned, the filtering step b) allows to replicate a three-dimensional workspace W having dimensions compatible with those of a laboratory, since the dataset D do no longer include the low frequencies which need large spaces to be reproduced. During step e) the electronic control unit is preferably moved with six degrees of freedom by applying thereto linear tension forces and rotational forces. In particular, said rotational forces are applied independently from said linear tension forces.

Advantageously, in the moving step e) the electronic control unit to be tested is linearly moved inside the three-dimensional workspace W by varying said linear tension forces.

Moreover, the control unit can be rotated around each of the three orthogonal axes X, Y, Z by varying said rotational forces.

Preferably, the linear tension forces and the rotational forces are set up taking into account the limited full-scale capability of the sensors, accelerometers and gyroscopes, currently available on the market.

For example, the full-scale of the accelerometers currently used is ±16 g, while the full-scale of the gyroscopes currently used is ±2000°/s.

In this way, the dynamic requirements of the machine applying the method of the invention can be reduced.

Advantageously, to avoid that the torques generated by the angular movements imparted to the control unit might affect the moving step e), such a moving step e) comprises a first feedback step wherein feedback linear tension forces are applied on the control unit to balance the torques generated by the angular movements of the control unit.

Advantageously, to avoid that the torques generated by the linear movements might affect the moving step e), such a moving step e) comprises a second feedback step wherein feedback torques are applied on the control unit to balance the torques generated by the linear tension forces.

Preferably, the first feedback step and the second feedback step are carried out in parallel.

Finally, the method comprises the step f of verifying along the time interval T1 if the activation signal is sent and/or internally recorded by the control unit when the activation algorithm identifies a danger situation.

Advantageously, said step f may further comprises a detection step wherein at least three linear acceleration measurements Acx, Acy, Acz of the electronic unit along the orthogonal axes X, Y, Z and at least three angular acceleration measurements Gsx, Gsy, Gsz of the electronic control unit around said three orthogonal axes X, Y, Z are detected during the moving step e) of the control unit.

Advantageously, by means of said additional detection step it is possible to verify whether the movements imparted to the control unit corresponds to the dataset D. In particular, it can be verified whether a deviation exists between the movements imparted to the control unit and the movements detected by the latter.

Reference is now made to FIGS. 2-5 showing a testing machine for implementing a method according to the present invention.

As shown in FIGS. 2-3, the testing machine 10 comprises a rigid structure 20, delimiting a three-dimensional workspace W.

Advantageously said three-dimensional workspace W can have reduced dimensions. For example, the workspace W can be a cube having a side of 1.5 m.

Furthermore, the testing machine comprises an end effector 40 which is connected to the rigid structure 20 by means of at least three adjustable cables 42.

Each cable 42 is adjustably extendable and retractable from an actuating device 22 connected to the rigid structure 20.

As schematically shown in FIG. 3, by means of the actuating devices 22 a linear tension T can be applied on the adjustable cables 42.

Preferably, each actuating device 22 comprises a cable reel on which a first end of the actuated adjustable cable 42 is wound; the second end of the actuated adjustable cable 42 being fastened to the end effector 40.

The cable reel is advantageously driven by an actuator motor for automatically retracting or releasing the adjustable cable 42.

In the preferred embodiment, the rigid structure 20 comprises four support members 24.

Advantageously, said support members 24 are positioned along the side edges of the rigid structure 20 so as to delimit the workspace W. The top ends of said support members 24 are preferably connected by transversal rods 25.

Each support member 24 can be provided with two actuating devices 22, one provided at the top and one provided at the bottom of the support member. In this embodiment, the adjustable cables 42 are preferably in the number of eight.

Advantageously, the corresponding adjustable cables 42 are fastened to the end effector 40 in a crossed manner, namely the adjustable cable actuated by the bottom actuating device is fastened to a top surface of the end effector 40, while the adjustable cable actuated by the top actuating device is fastened to a bottom surface of the end effector 40.

Similarly, as shown in FIG. 3, the adjustable cables 42 operated by the actuating devices positioned on a first support member 24 are preferably fastened in a crossed manner to a first side portion 40a of the end effector 40, while the adjustable cables 42 operated by the actuating devices positioned on an adjacent support member are fastened in a crossed manner to a second side portion 40b of the end effector 40; the first side portion 40a being opposite to the second side portion 40b.

In this way the torques, generated by the linear tension forces exerted by the adjustable cables, are partially self-balanced.

Preferably, the end effector 40 has a box shaped structure which is open at the top and at the bottom and the adjustable cables 42 are fastened at the edges of said box shaped structure.

With reference to FIGS. 4 and 5, the end effector 40 comprises a first casing 44 rotatably connected to an outer frame 43 to rotate around a first axis X.

Moreover, the end effector 40 comprises a second casing 46 rotatably connected to the first casing 44 to rotate around a second axis Y and a platform 48 rotatably connected to the second casing 46 to rotate around a third axis Z.

First casing 44, second casing 46 and platform 48 are thus directly or indirectly connected, in a rotatable manner, to the outer frame 43. Advantageously, the first casing 44 is directly connected to the outer frame 43, while the second casing 46 and the platform are indirectly connected to the outer frame 43. Preferably, first casing 44, second casing 46 and platform 48 are all housed inside the end effector 40.

The platform 48 is designed to support the control unit 50 to be tested. Preferably the platform 48 is provided with fastening means 52 for securely fastened thereto the control unit 50 (see FIG. 6).

The control unit 50 during the test is preferably powered by an external battery, not shown in the figures, which can be positioned on the platform 48.

Alternatively, the battery of the control unit 50, in order to reduce the torques acting on the platform 48, can be fastened to the first casing 44 or to the second casing 46.

First casing 44, second casing 46 and platform 48 are rotated by means of separated motors 54, 56, 58 provided at the end effector 40.

Preferably, said motors 54, 56, 58 are remotely controlled motors. Advantageously, said remotely controlled motors 54, 56, 58 can be controlled by using a radio communication protocol such as the Bluetooth protocol or the WIFI protocol or other similar protocols. Alternatively, said remotely controlled motors 54, 56, 58 can be powered and controlled by electrical signals conducted through at least three adjustable cables 42.

In detail, the motors 54, 56, 58 are designed to drive spindles 60, 62, 64 coupled to the first casing 44, the second casing 46 and the platform 48.

As shown in FIGS. 4 and 5, a first motor 54 is designed to drive a first spindle 60 by means of which the first casing 44 is connected to the outer frame 43. A second motor 56 is designed to drive a second spindle 62 by means of which the second casing 46 is connected to the first casing 44. A third motor 58 is designed to drive a third spindle 64 by means of which the platform 48 is connected to the second casing 46.

Preferably, said motors 54, 56, 58 are DC electrical motors.

Advantageously, the testing machine 10 comprises a controller not shown in the enclosed figures. Preferably, the separated motors 54, 56, 58, provided at the end effector 40, and the actuator motors 42 of the actuating devices 22, provided at the rigid structure 20, are in operative communication with said controller configured to provide a coordinate control of said motors 42, 54, 56, 58.

In particular, said controller, which can be for example a processor or a computer, is able to coordinate the motors of the end effector 40 and the motors of the rigid structure 20 so that the motors 22 of the rigid structure 20 are responsible of moving the end effector 40 linearly in the workspace W, while the motors 54, 56, 58 applied at the end effector are responsible of rotating the platform 48 around three main axes X, Y, Z.

In detail by means of the tension forces applied by the cables to the end effector 40 the latter is able to move vertically (upwards or downward) and/or horizontally (right or left) in the workspace W, while by means of the motors 54, 56, 58 acting on the end effector 40 the platform 48 can be rotated around the axes X, Y, Z by remaining inside the workspace.

The vertical movements in FIG. 3 are schematically indicated by the arrow P, while the horizontal movements are schematically indicated by the arrow F.

It is clear now how the present invention allows to achieve the predefined objects.

The method and the machine of the present invention are suitable to be used in a laboratory without affecting the reliability of the test. As a matter of fact, the movements imparted to the control unit are able to reproduce the movements of a user and thus the control unit can be tested with the same accuracy obtainable by carrying out a “real” crash test.

Moreover, the method and the machine of the present invention do not cause damages to the tested control unit or to any auxiliary equipment.

Therefore, the costs and the time involved in carrying out the test are reduced.

Furthermore, the method and the machine of the present invention permit to reproduce not only “real” crash situations, but also extreme situations wherein the behavior of the control unit can be tested so as to verify whether the activation algorithm needs to be updated for avoiding inflation not needed or false positive activation.

With regard to the embodiments of the method and the machine described above, the person skilled in the art may, in order to satisfy specific requirements, make modifications to and/or replace elements described with equivalent elements, without thereby departing from the scope of the accompanying claims.

1. A method for testing electronic control units of airbag protection devices adapted to be worn by a user; the method comprising the steps of:
(a) providing a dataset representing simulated movements of said user in a space defined by three axes, orthogonal to each other, in a time interval, said dataset comprising at least three linear acceleration measurements along said three axes and at least three angular acceleration measurements around said three axes;
(b) filtering the linear acceleration measurements of said dataset to remove the frequencies below a cut-off frequency along said three axes;
(c) uploading on the electronic control unit to be tested an activation algorithm; said activation algorithm being capable of identifying a danger situation for the user;
(d) programming the electronic control unit to be tested to send and/or internally record an activation signal when said activation algorithm identifies a danger situation;
(e) moving the electronic control unit within a three-dimensional workspace to replicate said dataset representing simulated movements as filtered in step (b);
(f) verifying along said time interval if the activation signal is sent and/or internally recorded by the electronic control unit when the activation algorithm identifies a danger situation.

2. The method according to claim 1, characterized in that the step (f) comprises a detection step wherein at least three linear acceleration measurements of the electronic control unit along said three orthogonal axes and at least three angular acceleration measurements of the electronic control unit around said three orthogonal axes are detected during the moving step (e) of the electronic control unit.

3. The method according to claim 1, characterized in that in step (a) said dataset representing simulated movements is obtained by:
(i) collecting real movement data of a user involved in a crash, or (ii) artificially creating movement data of a user.

4. The method according to claim 1, characterized in that in the filtering step (b) said cut-off frequency is comprised between 1 Hz and 20 Hz.

5. The method according to claim 1, characterized in that in the moving step (e) the electronic control unit is moved with six degrees of freedom by applying thereto linear tension forces and rotational forces; said rotational forces being applied independently from said linear tension forces.

6. The method according to claim 5, characterized in that in the moving step (e) the electronic control unit is linearly moved inside said three-dimensional workspace by varying said linear tension forces and is rotated around each of said three orthogonal axes by varying said rotational forces.

7. The method according to claim 6, characterized in that the moving step (e) comprises a first feedback step wherein feedback linear tension forces are applied on the electronic control unit to balance the torques generated by the angular movements of the electronic control unit.

8. The method according to claim 6, characterized in that the moving step (e) comprises a second feedback step wherein feedback torques are applied on the electronic control unit to balance the torques generated by the linear tension forces.

9. A testing machine for implementing the method according to claim 1, the testing machine comprising:
a rigid structure delimiting a three-dimensional workspace;
an end effector which is connected to the rigid structure by means of at least three adjustable cables, each of said at least three adjustable cables being adjustably extendable and retractable from an actuating device connected to the rigid structure;
the end effector comprising:
a first casing rotatably connected to an outer frame to rotate around a first axis;
a second casing rotatably connected to the first casing to rotate around a second axis;
a platform rotatably connected to the second casing to rotate around a third axis, the platform being designed to support the electronic control unit to be tested.

10. The testing machine according to claim 9, characterized in that the first casing, the second casing and the platform are rotated by means of separated motors provided at the end effector.

11. The testing machine according to claim 10, characterized in that said separated motors are remotely controlled motors.

12. The testing machine according to claim 10, characterized in that said separated motors are designed to drive spindles coupled to the first casing, the second casing and the platform.

13. The testing machine according to claim 9, characterized in that each actuating device comprises a cable reel on which a first end of the actuated adjustable cable is wound, the second end of the actuated adjustable cable being fastened to the end effector.

14. The testing machine according to claim 13, characterized in that said cable reel is driven by an actuator motor for automatically retracting or releasing the adjustable cable.

15. The testing machine according to claim 9, characterized in that said rigid structure comprising four support members, said support members being positioned along the side edges of the rigid structure, each support member being provided with two actuating devices.

16. The testing machine according to claim 10, further comprising a controller, said separated motors, provided at the end effector, and the actuator motors of the actuating devices, provided at the rigid structure, being in operative communication with said controller configured to provide a coordinate control of said motors.

17. The testing machine according to claim 16, characterized in that said controller is able to coordinate the motors of the end effector and the actuator motors of the rigid structure so that the actuator motors of the rigid structure (20) are responsible of moving the end effector linearly in the workspace, while the motors applied at the end effector are responsible of rotating the platform around three main axes.

18. The testing machine according to claim 9, characterized in that the end effector has a box shaped structure which is open at the top and at the bottom; the adjustable cables being fastened at the edges of said box shaped structure.

19. The testing machine according to claim 11, characterized in that said remotely controlled motors are controlled by using a radio communication protocol or WI-FI protocol.

20. The testing machine according to claim 11, characterized in that said remotely controlled motors are powered and controlled by electrical signals conducted through the at least three adjustable cables.
